(19) United States
(12) Patent Application Publication
(10) Pub. No.: US 2025/0368004 A1
(43) Pub. Date: Dec. 4, 2025

(54) VEHICLE HEAT EXCHANGER PERFORMANCE AND DEICING

(71) Applicant: FCA US LLC, Auburn Hills, MI (US)

(72) Inventors: Vivek A Jairazbhoy, Farmington Hills, MI (US); Drushan Mavalankar, Rochester Hills, MI (US); Matteo Maria Rostagno, Torino (IT); Francesco Lovuolo, Settimo Torinese (IT)

(21) Appl. No.: 18/679,948

(22) Filed: May 31, 2024

(51) Int. Cl. B60H 1/00; B60H 1/32

(52) U.S. Cl. CPC B60H 1/00907; B60H 1/00885; B60H 1/323

(57) ABSTRACT

A thermal system includes a refrigerant loop operable between a cooling mode and a heat pump mode, a compressor, and a heat exchanger. A thermal control system includes a controller programmed to monitor one or more conditions of the refrigerant loop related to an operational performance of the heat exchanger; estimate, via a pre-calibrated model of the thermal system, an expected operational performance of the heat exchanger when ice is not present and during the monitored one or more conditions; determine an instantaneous operational performance of the heat exchanger based on the monitored one or more conditions; compare the instantaneous operational performance to the expected operational performance to determine a performance degradation of the heat exchanger; and initiate a deicing operation of the heat exchanger when the performance degradation exceeds a predetermined threshold.

### FIELD

The present application relates generally to vehicle thermal systems and, more particularly, to a thermal control system for heat exchanger scheduled deicing based on performance degradation.

### BACKGROUND

Some electric vehicles (EVs) utilize a heat pump to provide heat to the vehicle cabin and/or powertrain. The heat pump includes a heat exchanger configured to extract heat from ambient air to heat a refrigerant. However, during operation, the refrigerant temperature in the heat exchanger can drop well below freezing. As a result, moisture in the ambient air can freeze and cause ice buildup on surfaces of the heat exchanger. Unattended, the ice and frost layers can block the airflow passages and potentially incapacitate the heat pump. Detection of excessive ice buildup is difficult, and detection of a resulting drop in performance of the heat exchanger is also complicated because the refrigerant can flow in a two-phase state, and convenient measurement of phase fractions may be hard to perform in a cost-effective manner. Accordingly, while such conventional systems do work for their intended purpose, there is a desire for improvement in the relevant art.

### SUMMARY

In accordance with one example aspect of the invention, a thermal system for a vehicle is provided. In one example implementation, the thermal system includes a refrigerant loop operable between a cooling mode and a heat pump mode, a compressor configured to circulate a refrigerant through the refrigerant loop, and a heat exchanger disposed on the refrigerant loop and configured to operate as a condenser when operating in the cooling mode and operate as an evaporator when operating in the heat pump mode. A thermal control system includes a controller having one or more processors.

The controller is programmed to monitor one or more conditions of the refrigerant loop related to an operational performance of the heat exchanger; estimate, via a pre-calibrated model of the thermal system, an expected operational performance of the heat exchanger when ice is not present and during the monitored one or more conditions; determine an instantaneous operational performance of the heat exchanger based on the monitored one or more conditions; compare the instantaneous operational performance to the expected operational performance to determine a performance degradation of the heat exchanger; and initiate a deicing operation of the heat exchanger when the performance degradation exceeds a predetermined threshold.

In addition to the foregoing, the described thermal system may include one or more of the following features: wherein the one or more conditions includes each of an ambient temperature, a refrigerant temperature and pressure at an inlet of the heat exchanger, a refrigerant pressure at an outlet of the heat exchanger, an airflow over the heat exchanger, a position of an expansion device located upstream of the heat exchanger, and a refrigerant flow rate in the refrigerant loop; and wherein the controller is programmed to monitor the compressor and determine the refrigerant flow rate based on a speed of the compressor, a compressor suction pressure, a compressor discharge pressure, and a compressor suction temperature.

In addition to the foregoing, the described thermal system may include one or more of the following features: an evaporator disposed on the refrigerant loop downstream of the heat exchanger, and a chiller disposed on the refrigerant loop downstream of the heat exchanger, wherein the chiller bypasses the evaporator; wherein the controller is further programmed to, prior to determining the instantaneous operational performance, direct refrigerant to bypass the evaporator or the chiller such that the refrigerant at an outlet of the heat exchanger is a saturated vapor; wherein the controller is further programmed to determine a heat exchanger exit enthalpy based on the monitored one or more conditions; and wherein the pre-calibrated model is a data driven artificial neural network (ANN).

In addition to the foregoing, the described thermal system may include one or more of the following features: wherein the deicing operation includes switching the refrigerant loop from the heat pump mode to the cooling mode such that hot refrigerant from the compressor transfers thermal energy to the heat exchanger to facilitate melting ice formed thereon; an evaporator disposed on the refrigerant loop downstream of the heat exchanger, a condenser disposed on the refrigerant loop upstream of the heat exchanger, a first expansion device disposed downstream of the condenser and upstream of the heat exchanger, and a second expansion device disposed downstream of the heat exchanger and upstream of the evaporator; and wherein the controller does not perform a periodic deicing of the heat exchanger.

In accordance with another example aspect of the invention, a method of operating a thermal control system is provided for a vehicle having a refrigerant loop operable between a cooling mode and a heat pump mode, and a heat exchanger configured to operate as a condenser when operating in the cooling mode and operate as an evaporator when operating in the heat pump mode. In one example implementation, the method includes monitoring, by a controller having one or more processors, one or more conditions of the refrigerant loop related to an operational performance of the heat exchanger; estimating, by the controller and via a pre-calibrated model of the thermal system, an expected operational performance of the heat exchanger when ice is not present and during the monitored one or more conditions; determining, by the controller, an instantaneous operational performance of the heat exchanger based on the monitored one or more conditions; comparing, by the controller, the instantaneous operational performance to the expected operational performance to determine a performance degradation of the heat exchanger; and initiating, by the controller, a deicing operation of the heat exchanger when the performance degradation exceeds a predetermined threshold.

In addition to the foregoing, the described method may include one or more of the following features: wherein the one or more conditions includes each of an ambient temperature, a refrigerant temperature and pressure at an inlet of the heat exchanger, a refrigerant pressure at an outlet of the heat exchanger, an airflow over the heat exchanger, a position of an expansion device located upstream of the heat exchanger, and a refrigerant flow rate in the refrigerant loop; and monitoring, by the controller, a compressor disposed on the refrigerant loop, and determining, by the controller, the refrigerant flow rate based on a speed of the compressor, a compressor suction pressure, a compressor discharge pressure, and a compressor suction temperature.

In addition to the foregoing, the described method may include one or more of the following features: wherein an evaporator is disposed on the refrigerant loop downstream of the heat exchanger, wherein a chiller is disposed on the refrigerant loop downstream of the heat exchanger, and wherein the chiller bypasses the evaporator; prior to determining the instantaneous operational performance, directing, by the controller, refrigerant to bypass the evaporator or the chiller such that the refrigerant at an outlet of the heat exchanger is a saturated vapor; and determining, by the controller, a heat exchanger exit enthalpy based on the monitored one or more conditions.

In addition to the foregoing, the described method may include one or more of the following features: wherein the pre-calibrated model is a data driven artificial neural network (ANN); wherein the deicing operation includes switching the refrigerant loop from the heat pump mode to the cooling mode such that hot refrigerant from a compressor transfers thermal energy to the heat exchanger to facilitate melting ice formed thereon; an evaporator disposed on the refrigerant loop downstream of the heat exchanger, a condenser disposed on the refrigerant loop upstream of the heat exchanger, a first expansion device disposed downstream of the condenser and upstream of the heat exchanger, and a second expansion device disposed downstream of the heat exchanger and upstream of the evaporator; and wherein the controller does not perform a periodic deicing of the heat exchanger.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example vehicle thermal system in accordance with the principles of the present application;

FIG. 2 is a schematic diagram of an example thermal control system in accordance with the principles of the present application;

FIG. 3 illustrates an example table of input data for an example algorithmic model of the vehicle thermal system utilized to determine heat exchanger performance, in accordance with the principles of the present application; and

FIG. 4 illustrates an example control logic flow for determining a performance degradation of the thermal system shown in FIG. 1, in accordance with the principles of the present application.

### DETAILED DESCRIPTION

As discussed above, an EV may operate a thermal system as a heat pump to extract heat from a front-end airstream, even when the ambient temperature is low, and transfer the heat energy to various components such as the vehicle cabin, battery, or electric machines in the EV powertrain. Because of low refrigerant temperatures in the front-end heat exchanger, ice and frost layers may form on the heat transfer surfaces and potentially affect performance of the heat exchanger and thermal system. Since ice detection is difficult, common practice is to periodically deice the front-end heat exchanger, whether or not ice is present, to avoid significant or catastrophic loss of heat exchanger performance. However, such periodic deicing consumes a significant amount of energy, so unnecessary deicing may dramatically reduce thermal performance (e.g., the ability to transfer thermal energy into or out of the system). Moreover, periodic deicing fails to account for environmental conditions such as rain, freezing rain, snow, sleet, and wet pavement (road splash), leading on occasion to underestimation of ice buildup.

Accordingly, described herein is a thermal control system configured to estimate the performance degradation of the outer heat exchanger (OHX) and initiate deicing only when a certain performance degradation threshold is reached, thus dramatically reducing unnecessary deicing. In one example, performance degradation is a quantified reduction in enthalpy change across the OHX compared to the nominal (expected) OHX performance (e.g., the enthalpy change across the OHX). In one example, the system compares the instantaneous measured performance against the nominal (expected) performance estimated using a pre-calibrated analytical representation such as, for example, an artificial neural network (ANN). The system also facilitates the monitoring of long-term performance degradation of the OHX due to sources other than icing such as, for example, heat transfer surface fouling or blockage and damage by debris. Accordingly, the system does not (or is not required to) perform periodic deicing and only initiates deicing when the degradation threshold is reached.

In one example, the thermal control system includes a real-time algorithm configured to estimate OHX performance degradation and initiate deicing if certain conditions are met and at predetermined time steps. When the vehicle is offline, before implementing the control strategy, a customized relationship is developed to estimate OHX performance in terms of real-time measurable quantities, captured by means of an analytical representation of nominal (e.g., zero ice buildup) OHX performance. The relationship may be a physics-based or a data driven model calibrated either against experimental data or against a model of the subsystem that contains the OHX and the relevant sensors that provide the inputs.

One example data driven representation is an ANN where development is accomplished by training a model against data collected by running an analytical model of the thermal system using a simulation tool, such as AMESIM. Other embodiments employ a physics-based real time model calibrated either against experimental data or against a detailed model of the subsystem. Example inputs for the model/simulation include ambient temperature, OHX inlet and exit pressures, OHX inlet temperature, air flow rate, and refrigerant flow rate. Example outputs of the simulation include the nominal (expected) OHX performance (e.g., the enthalpy change across the OHX) and the OHX exit “quality” (e.g., phase fraction). Front end airflow may be estimated using a model, with fan speed, vehicle speed, active grille shutter (AGS) position, and wind speed and direction (if available) as inputs.

In some systems, especially those with indirect heat pumps and an accumulator as the refrigerant reservoir, the temperature and pressure of the refrigerant downstream of the water-cooled condenser (e.g., upstream of the OHX expansion valve) are monitored such that the amount of subcooling below the liquid saturation temperature can be used in the control algorithm. In these cases, it is convenient to use these monitored quantities as inputs, rather than to add additional sensors upstream of the OHX, for example, to include the OHX expansion valve within the system modeled with the ANN, recognizing that the valve position is also known in real time and can hence be used as an input to the ANN during operation. In one example, it is assumed that the OHX expansion valve lies within the modeled system, although the underlying principles apply to all heat pump applications.

In developing an ANN, the data collected should cover the entire operating space. Space filling algorithms, such as SOBOL, may be used to generate the input design of experiment (DOE) for training the ANN. When a physics-based simulation tool is used to generate the data, some combination of inputs produced by the space filling algorithm may lie in an “infeasible” regime, i.e. the simulation tool may be unable to solve the case. This may be particularly problematic when the system includes the OHX expansion valve, and the valve position is used as a simulation input. One solution to this problem is to use the refrigerant flow rate as a simulation input because it has a well-defined range during operation, and to have the simulation tool output the steady state position of the valve. The ANN can then be trained to use the valve position as an input and to generate the refrigerant flow rate on output.

During real-time operation, the algorithm estimates the performance degradation of the OHX by comparing the instantaneous measured performance against the expected performance estimated using the pre-calibrated analytical representation. A deicing operation is initiated when the performance degradation exceeds a predetermined threshold level, while the rate of degradation lies in the range expected for icing, as opposed to blockage by debris or heat exchanger damage. The baseline nominal OHX performance can be measured periodically and the expectation gradually lowered due to the slow, long-term performance degradation attributable to heat transfer surface fouling. Sudden, persistent, or dramatic fall-off in baseline performance, which may be triggered by events such as blockage by debris, may be programmed to trigger a warning and a recommendation to service the vehicle.

In one implementation, the embodiments have two variations. In the first variation, the simulation inputs are also used as inputs in real-time to drive the ANN that predicts OHX performance. This may require a measurement or an estimation of the refrigerant flow rate. A direct measurement may involve additional components. Mass flow rate through the compressor may be estimated through a map with one or more inputs. In one example, the inputs include compressor speed (RPM), compressor suction pressure (Pa), compressor discharge pressure (Pa), and compressor suction temperature (° C.).

Compressor speed is known based on sensor input. Compressor suction pressure may be directly measured via a sensor or, alternatively, evaporator exit pressure may be utilized with a correction for the accumulator and plumbing. Compressor discharge pressure may be directly measured via a sensor or, alternatively, pressure at the water cooled condenser exit may be utilized with a correction for the condenser and plumbing. Compressor suction temperature may be measured directly via sensor or, alternatively, the vapor exiting the accumulator may be assumed as saturated and temperature may then be computed from the pressure. All corrections may be calibrated with data, experimental or otherwise.

In the second variation, the refrigerant flow rate input is replaced by the position of the OHX expansion valve, which is available in real time, while the nominal OHX performance and, if required, the nominal refrigerant flow rate and OHX exit quality are generated on output. In one example, OHX exit quality (phase fraction) is the mass fraction of the vapor in a two-phase liquid-vapor, also referred to as the vapor quality. Real time instantaneous measurement of OHX performance in heat pump mode may require knowledge of the OHX exit state. Since the accumulator is an equilibrium device, the refrigerant at the accumulator entrance at steady state is a saturated vapor. If the chiller and evaporator are inactive, the OHX outlet state and the accumulator inlet state may be identical or nearly identical, the difference being only due to the small thermal losses and pressure drops through the ducting. In this variation, when getting ready to make a performance measurement, if necessary, the chiller and evaporator are bypassed or deactivated to ensure that the refrigerant at the OHX outlet at steady state is a saturated (or near saturated) vapor. If the chiller and/or evaporator are active, their heat loads must be included in the calculation that estimates the OHX exit state from the presumed saturated vapor state at the accumulator inlet.

The pre-calibrated analytical representation (e.g., ANN) may then be utilized with the position of the OHX expansion valve as input to estimate the nominal performance of the OHX, while the instantaneous actual performance may be estimated either by neglecting the heat and pressure losses downstream of the OHX, or by estimating them using correlations, which may require estimation of the refrigerant flow, and subtracting the OHX inlet enthalpy from the OHX exit enthalpy.

The system may also employ a hybrid version of the two variations by utilizing an ANN with the position of the OHX expansion valve as input when the chiller and evaporator are inactive, and an ANN with Refrigerant Flow Rate as input when either the chiller or the evaporator is active.

In yet another hybrid version, an ANN with the position of the OHX expansion valve as input is utilized when the chiller and evaporator are inactive, and a periodic deicing scheduling procedure is used when either the chiller or the evaporator is active. In one example, the periodic deicing scheduling procedure is the same or similar to that described in commonly owned U.S. patent application Ser. No. 18/520,829, filed Nov. 28, 2023, the contents of which are incorporated herein in their entirety by reference thereto. Moreover, while the systems described herein are directed towards an accumulator-based system, it will be appreciated that other configurations are envisioned such as, for example a receiver-dryer system.

As such, the algorithm and control of the thermal control system is described above and in the following figures. Although the example vehicle thermal system is described as an indirect heat pump configuration that includes an accumulator as an expansion device, the features described herein may be utilized for other systems such as a direct heat pump system or heat pump system that include a receiver-dryer as an expansion device. It will be appreciated that various features of the control, such as critical temperatures and pressures that demarcate icing risks, are to be calibrated and determined for each particular type of vehicle and associated thermal system.

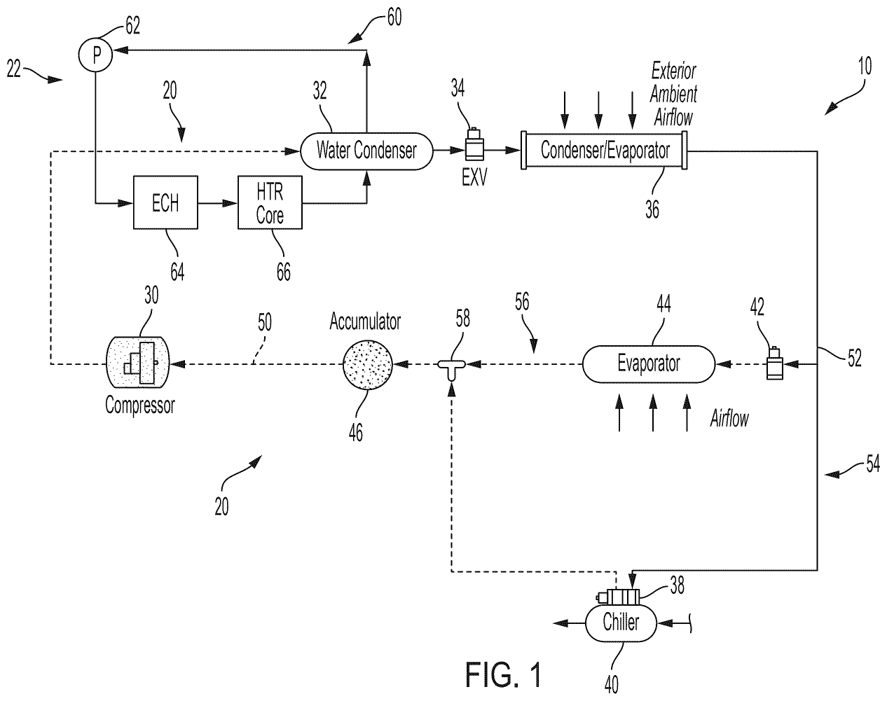

With initial reference to FIG. 1, an example vehicle thermal system is illustrated and generally identified at reference numeral 10. The thermal system 10 is configured to provide heating/cooling to various components of the vehicle such as the electric motor, high voltage battery system, power electronics (e.g., IDCM, PIM) and HVAC. In the example embodiment, the thermal system 10 includes a refrigerant loop 20 operable between an A/C (cooling) mode and a heat pump mode, as is well known in the art. The refrigerant loop 20 may be associated with a high temperature coolant loop 22, a low temperature coolant loop, and a battery system coolant loop (not shown). The refrigerant loop 20 is fluidly isolated from the high temp, low temp, and battery system coolant loops, which may be all fluidly connected by various valves. It will be appreciated that thermal system 10 is not limited to an in-vehicle application and may be utilized with various configurations of heat pumps, internal combustion engines, hybrids, etc.

In the example implementation, the refrigerant loop 20 is a vehicle air conditioning circuit that generally includes a compressor 30, a condenser 32, a first expansion device 34 (e.g., expansion valve), a condenser/evaporator heat exchanger 36, a second expansion device 38, a chiller 40, a third expansion device 42, an evaporator 44, and an accumulator 46. As previously noted, the refrigerant loop 20 is selectively switchable between the A/C mode and the heat pump mode. As such, depending on the mode of operation, the first heat exchanger 36 functions as either a condenser or an evaporator.

In A/C mode operation, a suction line 50 provides gaseous refrigerant to compressor 30, which subsequently compresses the refrigerant. The resulting compressed and heated refrigerant is then directed through the water condenser 32, which in the example embodiment, is thermally coupled to the high temperature cooling loop 22. In this mode, the first expansion device 34 is open (e.g., no restriction) and the refrigerant is directed to heat exchanger 36, which functions as a condenser to dissipate heat of compression and at least partially condense the refrigerant into a liquid. The cooled refrigerant is then directed to a first junction 52, which divides the coolant flow into a first branch 54 and a second branch 56.

The first branch 54 is configured to supply refrigerant to the second expansion device 38, which is a thermal expansion valve with an integrated shutoff valve. When the shutoff valve is in a closed position, refrigerant is prevented from flowing through first branch 54. When the shutoff valve is in an open position, refrigerant is able to flow through the first branch 54 to the second expansion device 38 where it is reduced in pressure and at least partially vaporized, thereby reducing the temperature of the refrigerant. The cooled vapor refrigerant is then supplied to chiller 40, where it is evaporated to provide cooling, for example, to coolant circulating within the battery system coolant loop (not shown). The resulting gaseous refrigerant is then returned to the compressor 30 via a second junction 58 to the suction line 50 where the cycle is then repeated.

The second branch 56 is configured to supply refrigerant to the third expansion device 42 (e.g., expansion valve), where it is reduced in pressure and at least partially vaporized, thereby reducing the temperature of the refrigerant. The cooled vapor refrigerant is then supplied to evaporator 44, where it is evaporated to providing cooling to the cabin air (e.g., via the HVAC air-handling subsystem). The resulting gaseous refrigerant is then returned to the compressor 30 via suction line 50 and the cycle is repeated.

In the heat pump mode operation, the first expansion device 34 is operated to expand the refrigerant, unlike during the A/C mode. The suction line 50 provides gaseous refrigerant to compressor 30, which subsequently compresses the refrigerant. The resulting compressed and heated refrigerant is then directed through the water condenser 32, where the heat from compression is dissipated into the high temperature coolant loop 22 and hence to the cabin, and the refrigerant at least partially condenses to a liquid. The cooled refrigerant is then supplied to the first expansion device 34 where it is reduced in pressure and at least partially vaporized, thereby reducing the temperature of the refrigerant.

The cooled refrigerant is then supplied to heat exchanger 36, where it is evaporated by absorbing thermal energy from ambient or ram air. As previously discussed, due to the cooled refrigerant entering, ice and frost may form and build up on the heat transfer surfaces of the heat exchanger 36, which in one example, is located at a front end of the vehicle. Although it will be appreciated that heat exchanger 36 may be positioned in any location of the vehicle. The resulting gaseous refrigerant is then returned to the compressor 30 via first and/or second branches 54, 56 and suction line 50, and the cycle is repeated.

With continued reference to FIG. 1, in one example implementation, the high temperature loop 22 circulates a heat transfer fluid or coolant (e.g., water) and generally includes a main circuit 60 having a pump 62, a high voltage heater 64, and a heater core 66. The main circuit 60 is fluidly coupled to the low temperature loop 20 via condenser 32. The pump 62 is configured to circulate the coolant around the main circuit 60, and the heater 64 is configured to selectively heat the coolant passing through the main circuit 60 when additional heating is desired. The heater core 66, which is a passenger cabin heat exchanger operably associated with a blower (not shown), is configured to receive heated coolant to thereby provide heating to air supplied to the passenger cabin by the blower.

As previously described, the thermal system 10 is configured to estimate the performance degradation of the outer heat exchanger 36 by comparing the instantaneous measured performance against the nominal performance estimated using a pre-calibrated analytical representation. In one example, performing the deicing operation includes switching operation of the refrigerant loop 20 from the heat pump mode to the A/C mode such that heat exchanger 36 operates as a condenser to melt the built-up ice/frost.

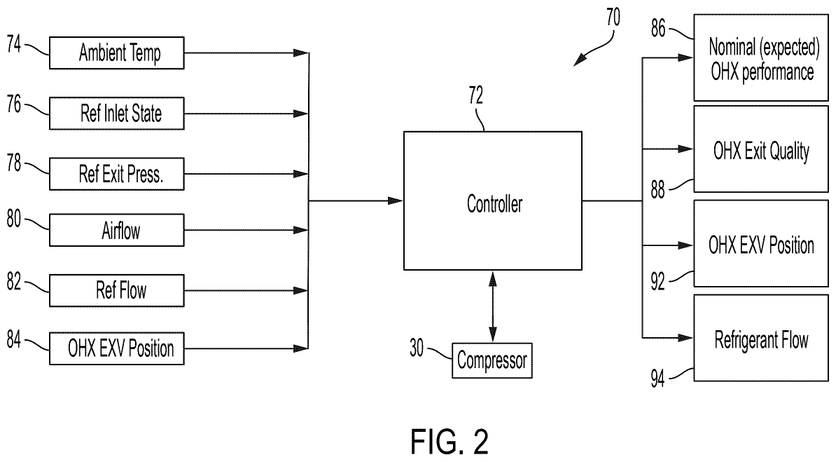

With reference now to FIG. 2, the thermal system 10 includes a thermal control system 70 to perform the operations described herein. The thermal control system 70 includes a controller 72 such as, for example, an engine control unit (ECU), which is in signal communication with various components, valves, and sensors of the vehicle. In the example embodiment, the controller 72 is in signal communication with one or more ambient temperature sensor 74, OHX inlet state (temperature and pressure) sensor 76, OHX outlet state (temperature and pressure) sensor 78, airflow sensor 80, refrigerant flow sensor 82, and OHX EXV position sensor 84. As such, sensors 74-84 are configured to provide input to controller 72. In one alternative example, OHX EXV position may be utilized as an input to provide a refrigerant flow output.

However, in some examples, sensors may be obviated and input data for airflow, ambient, refrigerant flow, EXV position, refrigerant inlet state, and/or refrigerant exit pressure may be obtained from calculations or other sources. As such, it will be appreciated that controller 72 may be in signal communication with or receive data from any suitable component that enables thermal control system 70 to function as described herein.

The ambient temperature sensor 74 is configured to sense a temperature of the ambient air. In other examples, controller 72 receives such data from another system. The OHX inlet state sensor 76 is configured to sense the state of the refrigerant (e.g., temperature and/or pressure) at an inlet of the expansion device 34. The OHX outlet state sensor 80 is configured to sense a temperature and/or pressure of the refrigerant at the exit of the heat exchanger 36. This may be utilized to determine heat transfer in the heat exchanger 36.

The airflow sensor 80 is configured to measure the airflow over the heat exchanger 36. In some embodiments, the airflow may be determined via other sensor inputs such a vehicle speed, fan speed (RPM and/or current signal), and/or AGS position, or alternatively, using a flow model such as a table or ANN that utilizes vehicle speed, fan speed, wind speed and angle, and/or AGS position as inputs. The refrigerant flow sensor 82 is configured to sense a refrigerant flow rate in the refrigerant loop 20, for example, upstream of expansion device 34 and/or downstream of heat exchanger 36. The EXV position sensor 84 is configured to sense a position or state of opening of the expansion device 34, and may be controlled by controller 72 to satisfy a desired target of the system 70.

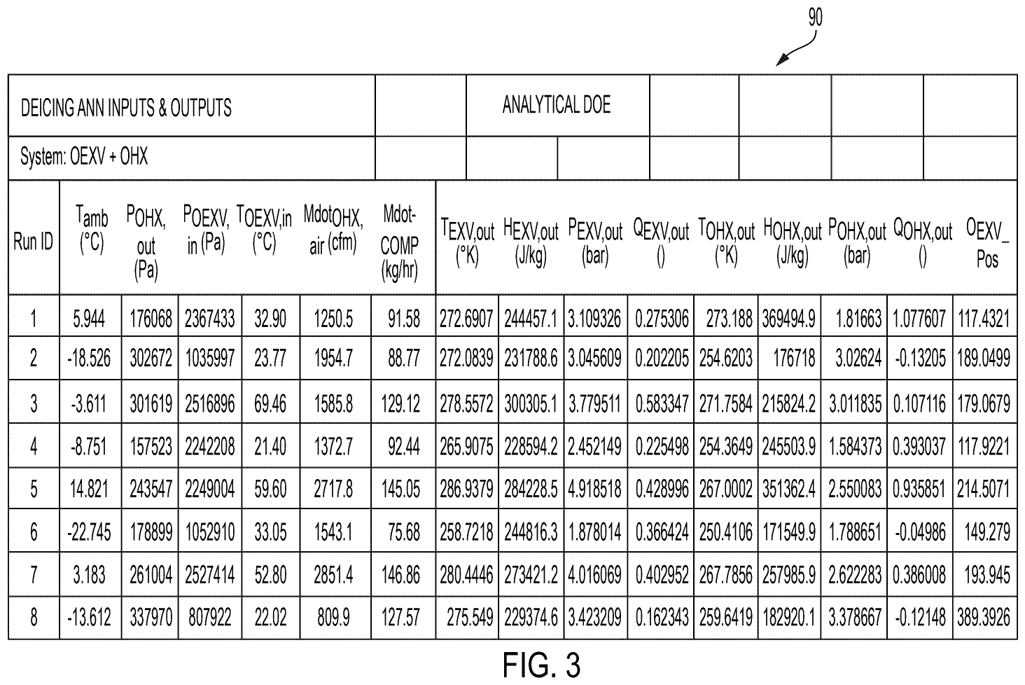

With continued reference to FIG. 2 and additional reference to FIG. 3, the controller 72 of thermal control system 70 is configured to receive input from one or more of sensors 74-82 and, in some examples compressor 30. The thermal control system 70 includes a model trained against data collected by running an analytical model of the thermal system 10 shown in FIG. 1, for example using a simulation tool. As shown in the example table 90 of FIG. 3, the model utilizes the sensor/data inputs to determine a nominal (expected) OHX performance 86 and an OHX Exit Quality 88 (FIG. 2). In some examples, additional outputs include OHX EXV position 92 and/or refrigerant flow 94 (FIG. 2).

In the example embodiment, the nominal (expected) OHX performance 86 is the enthalpy change across the OHX 36, for example, determined by subtracting output column two from output column six. Negative values of enthalpy change indicate that heat is leaving the refrigerant instead of entering it, which may thereby indicate the heat pump is not functioning as intended. In the example embodiment, the OHX Exit Quality is (Vapor) Quality <0,1>=mass fraction of vapor, where (Vapor) Quality>1 represents superheated vapor, and (Vapor) Quality<0 represents subcooled liquid.

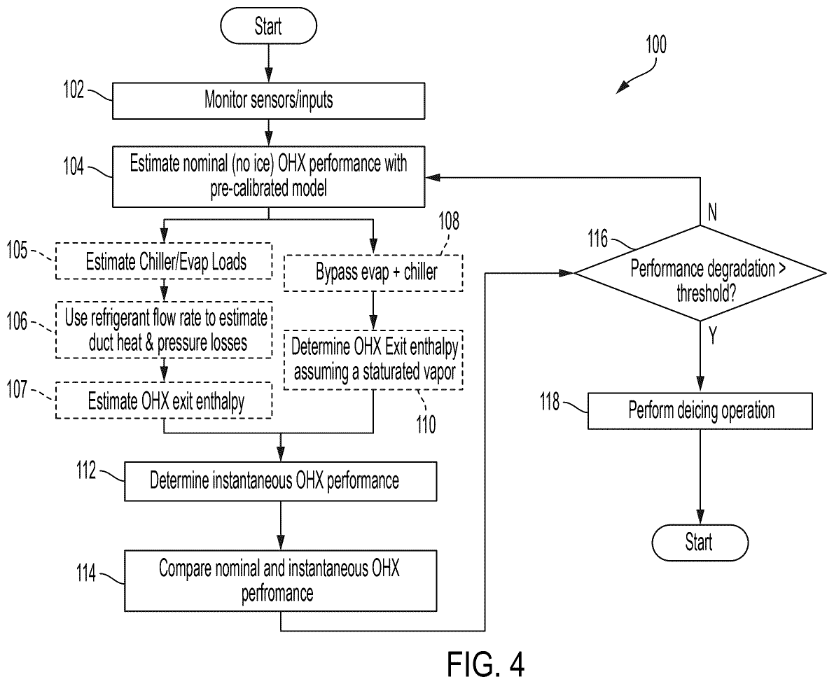

With reference now to FIG. 4, an example method 100 of operating thermal control system 70 to estimate performance degradation of OHX 36 and thereby determine the need for a deicing operation will be described. The method begins at step 102 where controller 72 (control) monitors one or more conditions of the refrigerant loop 20, such as sensor inputs (or other inputs) related to operational performance of OHX 36. In the example embodiment, control monitors sensors 74-84 and compressor 30. At step 104, control estimates the nominal (no ice) performance of the OHX 36. This is done using either a physics-based or data driven model (e.g., ANN) calibrated either against experimental data or against a detailed model of the thermal system 10 that includes the OHX 36, expansion device 34, and the relevant sensors (e.g., 74-84) that provide the inputs. In this way, control receives sensor inputs and utilizes the model to estimate how the OHX 36 should be performing without ice/frost buildup.

Control then proceeds to either step 105 or 108 depending on whether instantaneous OHX performance (step 112) is determined from an estimation of the chiller and/or evaporator heat loads and the duct-related heat and pressure losses (steps 105-107), or by bypassing the chiller and/or the evaporator (step 108) and neglecting the duct-related heat and pressure losses (e.g., assuming the OHX Exit state is a saturated vapor and inferring its enthalpy directly from its temperature and pressure) (step 110).

At step 105, control estimates the chiller and/or evaporator loads. In one example, this may be accomplished by estimating/measuring the coolant-side flow rate and temperature change (in the chiller), and HVAC air-side flow rate and temperature change (in the evaporator).

At step 106, control estimates the heat and pressure losses in the ducting between the OHX exit and the accumulator 46, requiring a refrigerant flow rate. In one example, this is a direct measurement via refrigerant flow sensor 82. In another example, the refrigerant flow rate is estimated based on inputs from compressor 30 such as, for example compressor speed, compressor suction pressure, compressor discharge pressure, and compressor suction temperature.

At step 107, assuming vapor saturation at the accumulator inlet, control estimates the OHX Exit enthalpy from the chiller and evaporator loads, the heat and pressure losses in the ducting, and the refrigerant flow rate. Control then proceeds to step 112.

At step 108, control bypasses (or deactivates) the chiller 40 and/or the evaporator 44. For example, this may include shutting off expansion device 42 and the path to the chiller 40 via expansion device 38, and using the bypass path that avoids the chiller 40. In this way, the refrigerant at the outlet of the OHX 36 at steady state is a saturated (or near) saturated vapor.

At step 110, control then determines the OHX Exit enthalpy from the temperature and pressure, where the refrigerant is assumed as a saturated vapor. For example, Exit Quality is assumed to be 1, and the enthalpy can be determined from the temperature and pressure (e.g., from the saturation curve on a P-H diagram, not shown). Between the OHX 36 and the accumulator 46, small changes in temperature and pressure may occur due to heat loss through the duct walls and pressure drop due to flow. These, and the corresponding enthalpy change, are estimated using standard heat transfer and flow corrections and, if needed, the corrected Exit Quality can be determined from the corrected enthalpy (e.g., from the P-H diagram). Control then proceeds to step 112.

At step 112, control determines the instantaneous OHX performance by subtracting the OHX inlet enthalpy from the OHX exit enthalpy calculated from either step 107 or 110. At step 114, control compares the estimated nominal OHX performance (step 104) and the instantaneous OHX performance (step 112) to determine a performance degradation of the OHX, for example, due to icing, blockage, damage, etc. At step 116, control determines if the performance degradation (step 114) is greater than a predetermined threshold, for example, indicating an ice buildup. If no, control returns to step 104. If yes, control proceeds to step 118 and initiates a deicing operation. Control then ends or returns to step 102.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A thermal system for a vehicle, comprising:
a refrigerant loop operable between a cooling mode and a heat pump mode;
a compressor configured to circulate a refrigerant through the refrigerant loop;
a heat exchanger disposed on the refrigerant loop and configured to operate as a condenser when operating in the cooling mode and operate as an evaporator when operating in the heat pump mode; and
a thermal control system including a controller having one or more processors, the controller programmed to:
monitor one or more conditions of the refrigerant loop related to an operational performance of the heat exchanger;
estimate, via a pre-calibrated model of the thermal system, an expected operational performance of the heat exchanger when ice is not present and during the monitored one or more conditions;
determine an instantaneous operational performance of the heat exchanger based on the monitored one or more conditions;
compare the instantaneous operational performance to the expected operational performance to determine a performance degradation of the heat exchanger; and
initiate a deicing operation of the heat exchanger when the performance degradation exceeds a predetermined threshold.

2. The thermal system of claim 1, wherein the one or more conditions includes each of:
an ambient temperature;
a refrigerant temperature and pressure at an inlet of the heat exchanger;
a refrigerant pressure at an outlet of the heat exchanger;
an airflow over the heat exchanger;
a position of an expansion device located upstream of the heat exchanger; and
a refrigerant flow rate in the refrigerant loop.

3. The thermal system of claim 2, wherein the controller is programmed to monitor the compressor and determine the refrigerant flow rate based on a speed of the compressor, a compressor suction pressure, a compressor discharge pressure, and a compressor suction temperature.

4. The thermal system of claim 1, further comprising:
an evaporator disposed on the refrigerant loop downstream of the heat exchanger; and
a chiller disposed on the refrigerant loop downstream of the heat exchanger,
wherein the chiller bypasses the evaporator.

5. The thermal system of claim 4, wherein the controller is further programmed to:
prior to determining the instantaneous operational performance, direct refrigerant to bypass the evaporator or the chiller such that the refrigerant at an outlet of the heat exchanger is a saturated vapor.

6. The thermal system of claim 5, wherein the controller is further programmed to determine a heat exchanger exit enthalpy based on the monitored one or more conditions.

7. The thermal system of claim 1, wherein the pre-calibrated model is a data driven artificial neural network (ANN).

8. The thermal system of claim 1, wherein the deicing operation includes switching the refrigerant loop from the heat pump mode to the cooling mode such that hot refrigerant from the compressor transfers thermal energy to the heat exchanger to facilitate melting ice formed thereon.

9. The thermal system of claim 1, further comprising:
an evaporator disposed on the refrigerant loop downstream of the heat exchanger;
a condenser disposed on the refrigerant loop upstream of the heat exchanger;
a first expansion device disposed downstream of the condenser and upstream of the heat exchanger; and
a second expansion device disposed downstream of the heat exchanger and upstream of the evaporator.

10. The thermal system of claim 1, wherein the controller does not perform a periodic deicing of the heat exchanger.

11. A method of operating a thermal control system for a vehicle having a refrigerant loop operable between a cooling mode and a heat pump mode, and a heat exchanger configured to operate as a condenser when operating in the cooling mode and operate as an evaporator when operating in the heat pump mode, the method comprising:
monitoring, by a controller having one or more processors, one or more conditions of the refrigerant loop related to an operational performance of the heat exchanger;
estimating, by the controller and via a pre-calibrated model of the thermal system, an expected operational performance of the heat exchanger when ice is not present and during the monitored one or more conditions;
determining, by the controller, an instantaneous operational performance of the heat exchanger based on the monitored one or more conditions;
comparing, by the controller, the instantaneous operational performance to the expected operational performance to determine a performance degradation of the heat exchanger; and
initiating, by the controller, a deicing operation of the heat exchanger when the performance degradation exceeds a predetermined threshold.

12. The method of claim 11, wherein the one or more conditions includes each of:
an ambient temperature;
a refrigerant temperature and pressure at an inlet of the heat exchanger;
a refrigerant pressure at an outlet of the heat exchanger;
an airflow over the heat exchanger;
a position of an expansion device located upstream of the heat exchanger; and
a refrigerant flow rate in the refrigerant loop.

13. The method of claim 12, further comprising:
monitoring, by the controller, a compressor disposed on the refrigerant loop; and
determining, by the controller, the refrigerant flow rate based on a speed of the compressor, a compressor suction pressure, a compressor discharge pressure, and a compressor suction temperature.

14. The method of claim 11, wherein an evaporator is disposed on the refrigerant loop downstream of the heat exchanger,
wherein a chiller is disposed on the refrigerant loop downstream of the heat exchanger, and
wherein the chiller bypasses the evaporator.

15. The method of claim 14, further comprising:
prior to determining the instantaneous operational performance, directing, by the controller, refrigerant to bypass the evaporator or the chiller such that the refrigerant at an outlet of the heat exchanger is a saturated vapor.

16. The method of claim 15, further comprising:
determining, by the controller, a heat exchanger exit enthalpy based on the monitored one or more conditions.

17. The method of claim 11, wherein the pre-calibrated model is a data driven artificial neural network (ANN).

18. The method of claim 11, wherein the deicing operation includes switching the refrigerant loop from the heat pump mode to the cooling mode such that hot refrigerant from a compressor transfers thermal energy to the heat exchanger to facilitate melting ice formed thereon.

19. The method of claim 11, further comprising:
an evaporator disposed on the refrigerant loop downstream of the heat exchanger;
a condenser disposed on the refrigerant loop upstream of the heat exchanger;
a first expansion device disposed downstream of the condenser and upstream of the heat exchanger; and
a second expansion device disposed downstream of the heat exchanger and upstream of the evaporator.

20. The method of claim 11, wherein the controller does not perform a periodic deicing of the heat exchanger.
